(19) United States
(12) Patent Application Publication
(10) Pub. No.: US 2014/0028547 A1
(43) Pub. Date: Jan. 30, 2014

(54) SIMPLE USER INTERFACE DEVICE AND CHIPSET IMPLEMENTATION COMBINATION FOR CONSUMER INTERACTION WITH ANY SCREEN BASED INTERFACE

(71) Applicant: STMicroelectronics, Inc., Coppell, TX (US)

(72) Inventors: Paul Bromley, Woodside, CA (US); George A. Vlantis, Sunnyvale, CA (US); Jefferson E. Owen, Freemont, CA (US)

(21) Appl. No.: 13/952,359

(22) Filed: Jul. 26, 2013

Related U.S. Application Data
(60) Provisional application No. 61/676,180, filed on Jul. 26, 2012.

(51) Int. Cl. G06F 3/0346

(52) U.S. Cl. CPC G06F 3/0346
USPC 345/156

(57) ABSTRACT

A user control device operates with a variety of host systems, including computers, televisions and recorded or streaming video playback devices, and gaming systems, is mounted to the user's hand. The user control device includes audio and optical sensors for capturing audio and image or video data, allowing the use of voice commands and display focal center alignment control for “swiping” or scrolling the display. A combined inertial (accelerometer(s), gyroscope(s) and a magnetometer) sensor detects translation and rotation movement of the user control device for pointing and selecting within real or virtual three-dimensional space. Haptic (e.g., vibration) feedback units provide tactile feedback to the user to confirm double clicks and similar events.

The present application incorporates by reference the subject matter of U.S. Provisional Patent Application No. 61/676,180 entitled (“A SIMPLE USER INTERFACE DEVICE AND CHIPSET IMPLEMENTATION COMBINATION FOR CONSUMER INTERACTION WITH ANY SCREEN BASED INTERFACE”) and filed on Jul. 26, 2012.

### TECHNICAL FIELD

The present application relates generally to user control devices and, more specifically, to a user “pointing” and selection actuation device for use with a variety of different systems.

### BACKGROUND

A variety of user control devices exist for computers, television, video receivers, digital versatile disk (DVD) players and the like, including keyboards, various types of mouse, trackball or touch pad pointer control devices, touchscreens, etc. Each have various disadvantages, often including cost and user convenience for remote interaction with user controls on a display. There is a lack of a simple, self-charging portable device enabling a simple user interface with a variety of screen-based user interfaces, including televisions, computers and display devices.

There is, therefore, a need in the art for an improved screen-based interface user interaction device.

### SUMMARY

A user control device operates with a variety of host systems, including computers, televisions and recorded or streaming video playback devices, and gaming systems, is mounted to the user's hand. The user control device includes audio and optical sensors for capturing audio and image or video data, allowing the use of voice commands and display focal center alignment control for “swiping” or scrolling the display. A combined inertial (accelerometer(s), gyroscope(s) and a magnetometer) sensor detects translation and rotation movement of the user control device for pointing and selecting within real or virtual three-dimensional space. Haptic (e.g., vibration) feedback units provide tactile feedback to the user to confirm double clicks and similar events.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 illustrates an exemplary embodiment of a Simple User Interface Device according to one embodiment of the present disclosure;

FIG. 1A is a high level block diagram of selected electrical and electronic components of the Simple User Interface Device of FIG. 1; and

FIGS. 2A through 2E are high level flowcharts illustrating processes implemented by a Simple User Interface Device in accordance with various embodiments of the present disclosure.

### DETAILED DESCRIPTION

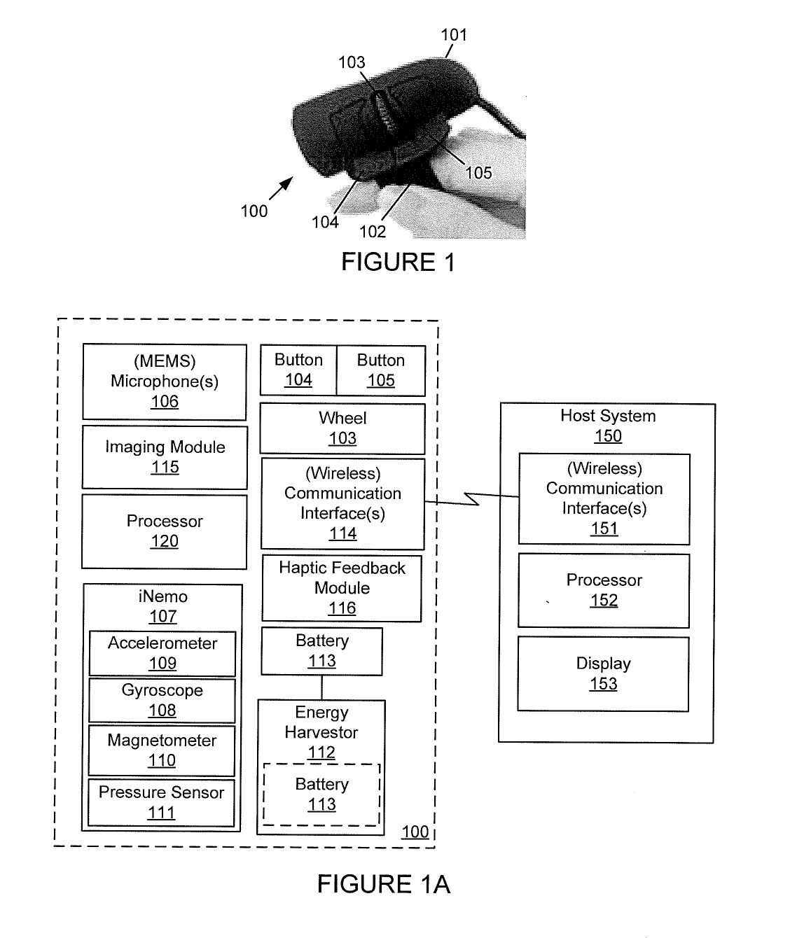

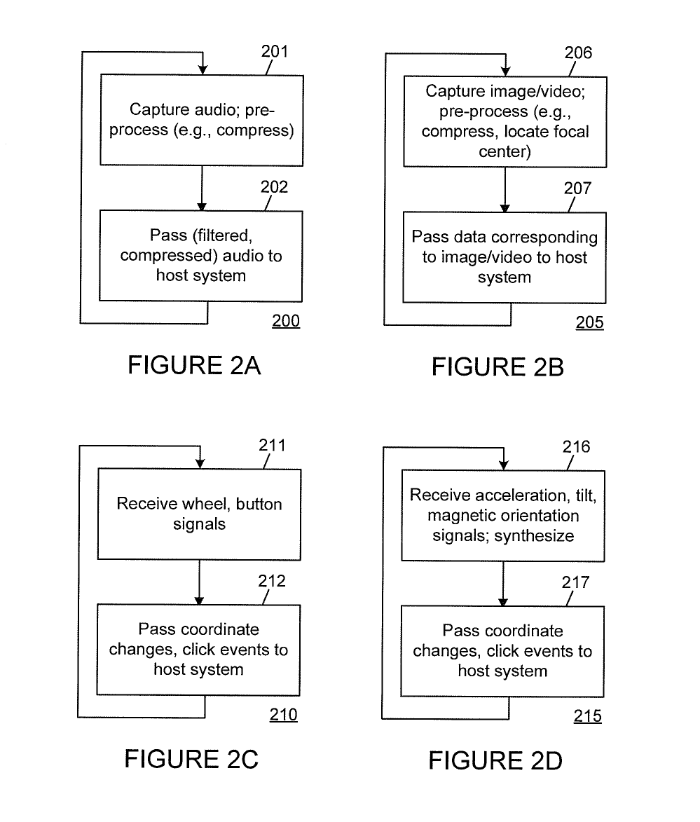

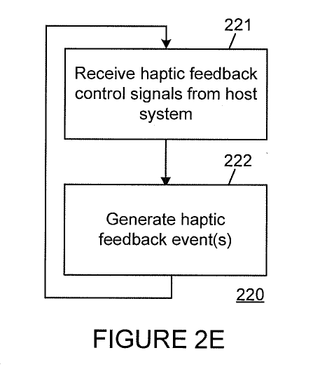

FIGS. 1 through 2E, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system.

FIG. 1 illustrates an exemplary embodiment of a Simple User Interface Device according to one embodiment of the present disclosure. In the example depicted, the Simple User Interface Device (or “user control device”) 100 is disposed within a housing 101 designed to store, protect, and provide structural support for the components of the user control device 100. The housing 101 includes a mounting portion 102 configured to allow the user control device 100 to be mounted upon a body part of the user. In the example of FIG. 1, the mounting portion 102 is an index finger ring that can preferably to adjustably sized to slide onto and be retained by friction fit upon the first finger of the user between the end-most joint and the middle joint, allowing the user's thumb to be employed as the selecting digit of the user's hand. The mounting portion may be a rigid structure, such as an annular plastic ring, or may alternatively be formed by an elastic band or by a strap with (for example) Velcro regions allowing one end of the strap to be secured to the other. In alternative embodiments, the mounting portion may alternatively allow the device 100 to be mounted upon the second or “middle” finger of the user, on both the first and second fingers of the user's hand together, or on a portion of the user's palm.

The user control device 100 also includes a wheel 103, for scrolling in accordance with the functionality of wheels on known mice and other pointing devices. The user control device 100 further includes left and right “buttons” 104 and 105, respectively, which like control clicking in accordance with the functionality of wheels on known mice and other pointing devices. As apparent from FIG. 1, the buttons 104 and 105 are actually protruding, spring-biased levers.

FIG. 1A is a high level block diagram of selected electrical and electronic components of the Simple User Interface Device of FIG. 1. It should be understood that other embodiments may include more, less, or different components. The user control device 100 includes a sensory system configured to provide a handheld or finger-mounted (as an index finger ring) self-charging portable device enabling a user to interface with a television, a computer, an optical disc (DVD or Blu-Ray) player, a gaming unit display, or some other display device through pointing by movement of the index finger and thumb selection.

The user control 100 integrates several capabilities into a single System-on-Chip (SoC) or set of integrated circuits (ICs) mounted within the housing 101. Those devices individually or collectively implement one or more of the following features (including any permutation of possible subsets):

A simple click/scroll function such as that described in U.S. Pat. No. 7,683,882, which is incorporated herein by reference, are provided using wheel 103 and buttons 104 and 105 described above.

An audio/speech capture function is provided via one or more micro-electro-mechanical system (MEMS) microphones 106, to enable speech/voice recognition for voice commands or the like. Only one microphone 110, or a number of different microphones all or some part of which may be MEMS microphones, may be placed on different portions of the user control device 100 oriented to serve different primary functions (e.g., capturing speech by the user or sampling background noise for speech processing). The micro-phone(s) 110 may be directly coupled to one or more (wireless) communication interface(s) 114, or indirectly connected via a processor (or controller) 120. The microphones 110 are coupled to and powered by a power source, discussed in further detail below, and are configured to capture sounds to enable the user control device 100 to perform speech and/or voice recognition and the like. In addition, captured audio (e.g., speech) may be communicated to the host system 150 for other uses, such as transmission to a remote system as part of audio communications (for example, between remotely located players of a multi-player video game).

A sensor fusion output from combined sensor device 107 (which includes gyroscope(s) 108, accelerometer(s) 109, magnetometer 110, and/or pressure sensor 111) to detection the relative position and/or orientation (attitude) of the user control device 100 in three dimensional (3D) space. Combined sensor device 107 may be implemented by, for example, iNertial module (“iNemo®”) nine-axis system-on-board (SoB) multi-sensor inertial measurement unit available from STMicroelectronics, Inc. Outputs from this combined sensor device 107 control the pointing function as discussed in further detail below.

One or more wired or wireless communication interfaces 114 exploiting communication link(s) such as Universal Serial Bus (USB), Firewire, WiFi, Bluetooth, Zigbee, and/or EnOcean wireless standard communication links, is provided in user control device 100 to allow communication with a variety of host systems of the type described above.

User control device 100 further includes a (wireless) energy harvesting unit 112 using motion and/or heat to generate electrical energy in accordance with the known art for recharging a thin film battery 113, which may be internal to or external from energy harvesting unit 112 as depicted in FIG. 1A.

An image sensor or module 115 (e.g., a still image or video camera) within user control device 100 captures image or video data, which may be transmitted in the same manner and for the same reasons described above with respect to audio data. The imaging module 115 receives still image or video data from one or more optical sensors, preferably including one mounted within the user control device 100 facing toward the display screen of the host system and one facing toward the user. The imaging module 115 is selectively configurable to obtain and process image or video from either optical sensor at a given time. In addition, the imaging may be used in conjunction with buttons 104-105 for select, double click and/or swipe functions (among others) by capturing images of the screen 153 to transmit to the host system for a determination of the location of a center of focus of the camera, which may be indicated to the user by displaying markings on the screen 153 similar to either a cursor or conventional photographic focus and framing indicators.

A haptic or tactile feedback module 116 provides tactile sensory feedback (e.g., vibration) to the user of user control device 100 in accordance with the known art. For example, upon double clicking (either by actually double clicking one of buttons 104-105 or by detecting motion of the user control device 100 by, for instance, double-dipping or any similar repeated double motion the device), vibration of the user control device 100 can confirm the double click to the user.

The sensory system of the Simple User Interface Device 100 includes one or a plurality of microphones 110, a processor 120, an iNemo® inertial-module 130, an imaging input module 140, a haptic feedback module 150, a communication interface 160, an energy harvester 170, and an energy source 180.

The user control device 100 preferably includes a processor 120 controlling operation of the device, including the various subsystems 103-116 discussed above. Although not shown in FIG. 1, the processor 120 is directly or indirectly coupled to the various subsystems by communications signals (e.g., a bus and/or one or more direct signal connections) and transmits/receives control signals, measurements or other data signals (including data packets), requests and acknowledgements and/or analog voltages to and from such subsystems in accordance with the known art. For example, the processor 120 may be configured to receive audio input from the microphone(s) 106, such as the voice of a user, and may be configured to perform audio compression or other digital signal processing of the sound inputs received from the microphone(s) 106 with processing to eliminate background noise, if needed for speech recognition of voice commands or the like.

While the processor 120 may be configured to implement speech recognition and/or voice recognition, alternatively the processor 120 may simply pass raw speech data or partially processed speech data (e.g., by performing audio compression) to a host system 150 for such speech recognition and the like in that device. The processor 120 is preferably employed to communicate voice commands to the host 150 via the communication interface(s) 114 (and a counterpart wireless communications interface 151 within the host system 150), for voice control by the user over the operation of the host system 130. The processor 120, alone or in conjunction with a processor 152 within the host system 150, may also implement voice-to-text conversion, either for display on a screen 153 of text-based renditions of the user's speech (e.g., for gaming), or to implement commands to the host system 150, or both.

The processor 120 may also be configured to implement a protocol stack for one or more communication protocols, either within the user control device 100 (that is, between functional modules and/or integrated circuits) or with external devices via the communication interfaces 114.

As noted above, the user control device 100 includes a combined sensor module 107, preferably an iNemo® inertial module that includes accelerometers 109, gyroscopes 108, a magnetometer 110, and a pressure sensor 111. Alternatively, the combined sensor module 107 may include some subset of those sensors. In operation, the sensors within combined sensor module 107 provide an indication of the position and orientation/attitude of the user control device 100. The processor 120 may fully or partially process the signals from combined sensor module 107, passing either the raw signals or, preferably, at least partially processes signals to the host system for use in pointing and selecting in 3D space or for rotating either or both of the image displayed or the perspective relative to an image environment in 3D space.

For example, if the long axis of the user control device 100 (aligned with the length of the user's finger) is taken as one primary axis, rotation of user control device 100 about the long axis (“roll”) may be employed by the user to signal a desire to move a cursor on the display 153 to the up or down, depending on the direction of the rotation. Similarly, rotation of user control device 100 while keeping the long axis within the same horizontal plane (“yaw”) may be employed by the user to signal a desire to desire to move a cursor on the display 153 to the right or left, depending on the direction of rotation. Rotation of user control device 100 while keeping that axis within the same vertical plane (“pitch”) may be employed by the user to “swipe” to a different tile or page. Translation-only movement of user control device 100 toward or away from the user may zoom in or zoom out on the image being displayed on the screen 153.

Alternatively, the host system 150 and the user control device 100 may be configured such that translation-only movement of the user control device 100 to the right or left along the long axis (without change in pitch) indicates a user command to move the cursor to the right or left (that is, to move the center of focus of the image on the display to the right or left), scrolling the display and bringing additional portions of the image onto the screen while moving other portions off the opposite edge of the screen. In this alternative, a change in the pitch of the user control device may, for example, move a character representing the user's perspective in a game to the right or left within the “landscape” being displayed. Similarly, translation-only movement of the user control device 100 up or down may cause the center of focus to change, while a change in the yaw attitude of the user control device 100 effects movement of the character. In like manner, translation-only movement “forward” (away from the user) and “back” (toward the user) may zoom in or out, while a change in the roll attitude effects movement of the character.

As apparent, translation movement in each of three independent directions and rotation movement around each of three independent axes provided six control mechanisms for altering a display on the screen 153 or for altering a perspective (e.g., orientation, degree of zoom) of the image. In combination with buttons 104-105, the translation and rotation movement of user control device 100 may be employed to select and scale or otherwise alter displayed images by pressing and holding one of the buttons while effecting such movement.

While not shown in FIG. 1A, the inertial module of combined sensors 107 and the components included therein are coupled to the communication interface 114. At least the inertial module, if not the entire combined sensor subsystem 107, the components included therein is/are preferably configured to provide sensor fusion outputs, by which the data from different types of sensors (accelerometers, gyros, magnetometer, etc.) are synthesized into more powerful data types rather than simply being passed in raw form to the host system 150 or an application executing on the host system. The sensor fusion outputs enable the host system 150 to understand the relative position and/or orientation of the user control device 100 in 3D space, and to evaluate and more quickly respond to both translation (in three dimensions) and rotation (about three axes) of the user control device 100. By performing processing to generate the sensor fusion data within processor 120 rather than in processor 152, the resources of processor 152 are freed for other tasks, such as graphics rendering.

The user control device 100 of the exemplary embodiment includes an imaging input module 115 configured to enable a user to point and/or move a pointer in two dimensional or (virtual) three dimensional space of a display for the host system 150, double-click or otherwise select (with or without haptic feedback) an object or display item on the display 153, and swipe, drag, and/or scroll in two or three dimensions. The pointing, selecting, swiping, dragging, and scrolling may be in response to movement (translation and/or rotation) of the user control device 100 in real three-dimensional space, without tactile contact or proximity to the user control device to an underlying or other reference surface, including without limitation a touchscreen or touchpad input device or detection of movement relative to a surface in the manner of, for instance, a surface-enabled mouse. In addition, the user control device 100 can allow the user to rotate a display item in three (virtual) dimensions, based upon corresponding translation and/or rotation of the user control device 100 in real three dimensional space. These functions may all be processed at the host system 150 in response to signals received from the user control device 100.

As noted above, the imaging input module 115 may optionally be implemented in the manner described in U.S. Pat. No. 7,683,882, the content of which is incorporated by reference herein. The imaging input module 115 is used to actuate performance of the select, double-click and swipe (or drag or scroll) functions described above. The imaging input module 115 is coupled to the energy source 113 and the communication interface(s) 114, enabling the imaging input module 115 to receive electric energy from the energy source 113 and to communicate with the host system 150.

The user control device 100 in the exemplary embodiment includes a haptic feedback module 116 configured to provide haptic feedback to a user by mechanical stimulation of the tactile senses through force/pressure, vibration, or other movement that may be sensed by the user, or optionally by heat or coolness generated by thermoelectric devices (not shown) within portions of the user control device 100 that contact the user's skin. For instance, in response to a user command to select or double-click a highlighted user control on the display of the host system 150, the haptic feedback module 116 can provide haptic feedback confirming receipt for execution of the user command. As with other modules, the haptic feedback module 116 is coupled to the energy source 113 and the communication interface(s) 114, to receive electric energy from the energy source 113 and to communicate with the host system 150.

While the haptic feedback module 116 is preferably included in an active state within the user control device 100, actuation or delivery of haptic feedback may be an optional feature that the user may (one time, or repeatedly or at different times) chose to enable or disable. Haptic feedback may also be automatically disabled when available battery power falls below certain levels.

As described above, the sensory system 107 is communicably coupled to one or more communication interface(s) 114 and, but such connection, is thus communicably coupled to the host system 150 via a wireless communications medium. The communication interface 114 includes one or any combination of: a Bluetooth interface; a ZigBee interface; an EnOcean Wireless Standard interface; or other suitable—and preferably low power—wireless interface(s). The wireless communications medium is preferably utilized in accordance with one or any combination of: a near field communication (NFC); any version of (or multiple versions of) Wireless Fidelity (“Wi-Fi”) (e.g., IEEE 802.11a, b, g, and/or h) communications; BLUETOOTH low energy (BLE) communications; EnOcean wireless communications: ZigBee wireless communications; or any other suitable wireless communications protocol. The communication interface(s) 114 enable the microphone(s) 106, the processor 120, the inertial-module 107, the imaging input module 106, and the haptic feedback module 116 to communicate with the host 150.

In the exemplary embodiment, the user control device 100 includes an energy harvester 112 configured to absorb at least one of kinetic energy, light energy and thermal energy and store the absorbed energy in the energy storage 113. The energy harvester 112 is configured to use one or any combination of: motion, light and heat. In the exemplary embodiment, the energy harvester 112 is configured to removably couple to the body of a user, such as by a an adhesive pad or covering (e.g., a glove), and to thereby harvest the user's body heat and/or kinetic energy from bodily motion, as well as light energy from ambient sources. In the example depicted, the energy harvester 112 is either coupled to or integrated with or includes the power source 113 within user control device 100, although alternatively the energy harvester 112 may be separate from a remainder of the user control device 100 but coupled to the power source 113. In either case, the energy harvester is configured to transmit energy to charge the power source (battery) 113.

The power source 113 in the exemplary embodiment of the user control device 100 is preferably a rechargeable, thin film battery configured to store energy received from the energy harvester 112 or other (external) sources and to provide electric energy to the other components (microphone(s) 106, processor 120, inertial module 107, imaging input module 115, and haptic feedback module 116) of the user control device 100. Indicators for remaining battery power and/or low battery power may be provided on the user control device 100 in a location prominently visible to the user. Optionally, removable and replaceable batteries may be employed for the power source 113.

The host system 150 is not part of the user interface device 100. As shown in FIG. 1A, the host system 100 may include one or more screens or display devices 153, as well as other output (e.g., audio) subsystems, and includes a processor 152. The processor 152 of the host system 150 is configured to receive inputs from the user control device 100 via the wireless link(s) 195. For example, in response to receiving a voice command input from the user control device 100, the processor 152 may be configured to process the voice command. The processor 152 may also be configured to process text input from the user control device 100, and user input and/or commands received in response to movement of the user control device 100 in real three dimensional space. In response to such inputs or commands, the processor 152 may cause one or more of the displays to display images (namely, in virtual 3D space) or indicate movement or control actions corresponding to the user inputs or commands received in the manner described above. The user commands received in 3D space include one or any combination of: to point, select, double click, select and scale by holding, rotate, and scroll. By way of further example, in response to the imaging module 115 (and/or buttons 104-105) sending a double click user input to the host system 150, the processor 152 may be configured to cause haptic feedback to be provided to the user via the haptic feedback module 116 confirming the double-click input.

As noted above, the housing 101 preferably includes a support configured as an adjustable diameter ring to be fitted to the user's index finger, leaving the thumb free to serve as a control digit. As also described above, the adjustable diameter ring may be secured to a glove formed of an expandable fabric and include at least portions or pads therein forming thermal energy conversion sources contacting portions of the body of the user (e.g., the palm of the user's hand in the example disclosed) to capture energy for the energy harvester 112. Of course, the portion of the energy harvester 112 that attaches to the user's body is necessarily not wholly contained within the housing 101, but is coupled to the housing.

Integration of 3D MEMS positioning with speech recognition in accordance with the present disclosure allows interaction with any screen up to the level currently provided by a mouse and keyboard. Because the microphone will generally always be in close proximity to the user, less noise compensation is required for comparable performance.

FIGS. 2A through 2E are high level flowcharts illustrating processes implemented by a Simple User Interface Device in accordance with various embodiments of the present disclosure. The processes 200, 205, 210, 215 and 220 depicted and described are performed by or executed within the processor 120 using signals from the MEMS microphone(s) 106, imaging module 115, wheel 103 and buttons 104-105, and combined sensor module 107, and signals to haptic feedback module 116. Each of the processes depicted, once started in response to a control signal from the host system, runs iteratively until stopped based upon another control signal from the host system. Those skilled in the art will understand that the processes depicted and described are merely exemplary, and may be suitably modified for different applications executing within a host system to which user control device is communicably coupled.

FIG. 2A illustrates an audio process 200, in which audio data is captured from the MEMS inputs and optionally pre-processed (step 201), as by filtering background noise using audio captured by one or more microphones facing away from the user and/or compressing the audio for more efficient communication. The pre-processed audio is then transmitted to the host system (step 202) for use in controlling an application executing on the host system or to be transmitted to a remote system in connection with such an application.

FIG. 2B illustrates a graphics or video process 205, in which still images or video is captured and optionally pre-processed (step 206). Whether the optical system captures still images or video and the type of pre-processed performed may be configurable depending upon the application executing within the host system. For example, still images may be captured when the application executing on the host system uses the optical system as part of user control, the pre-processing may involve determining a center of focus on the display screen of the host system of the image captured by the user control device. As another example, video of the user may be captured for transmission to a remote system when the host system is a gaming device. Data corresponding to captured image or video is then transmitted to the host system 150. The transmitted data may be simply coordinates of the focal center, or may be compressed video.

FIG. 2C illustrates a user scrolling and selection process 210. The user control device 100 receives signals from the wheel 103 and buttons 104-105 (step 211), and passes corresponding display coordinate changes and click events to the host system (step 212).

FIG. 2D illustrates a user control device movement process 215. Acceleration, tilt and magnetic orientation (relative to the earth's magnetic field) signals are received from the accelerometers, gyroscopes and magnetometer, respectively, and are optionally synthesized into position and orientation coordinates for the user control device (step 216). Those position and orientation coordinates are transmitted to the host system (step 217). By comparison with stored prior position and orientation coordinates, the host system can determine movement of the user control device by the user and respond accordingly.

FIG. 2E illustrates a haptic feedback process 220. The user control device receives haptic feedback control signals from the host system (step 221), and generates haptic feedback event(s) based upon such control signals (step 222). For example, vibration may be produced to confirm a double-click event or heat or cooling by a thermoelectric device as an alert.

While each process flow and/or signal or event sequence depicted in the figures and described herein involves a sequence of steps, signals and/or events, occurring either in series or in tandem, unless explicitly stated or otherwise self-evident (e.g., a signal cannot be received before being transmitted), no inference should be drawn regarding specific order of performance of steps or occurrence of signals or events, performance of steps or portions thereof or occurrence of signals or events serially rather than concurrently or in an overlapping manner, or performance the steps or occurrence of the signals or events depicted exclusively without the occurrence of intervening or intermediate steps, signals or events. Moreover, those skilled in the art will recognize that complete processes and signal or event sequences are not illustrated or described. Instead, for simplicity and clarity, only so much of the respective processes and signal or event sequences as is unique to the present disclosure or necessary for an understanding of the present disclosure is depicted and described.

Certain words or phrases used throughout this patent document have the following definitions: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller might be centralized or distributed, whether locally or remotely. Definitions for other words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments

While this disclosure has described certain embodiments and generally associated methods, alterations and permutations of these embodiments and methods will be apparent to those skilled in the art. Accordingly, the descriptions of example embodiments do not define or constrain this disclosure. Other changes, substitutions, and alterations are also possible without departing from the spirit and scope of this disclosure, as defined by the following claims.

What is claimed is:

1. A user control device, comprising:
a housing;
a support affixed to the housing, the support configured to mount the housing upon a portion of a hand of a user such that the housing moves in tandem with movement of the portion of the user's hand;
at least one optical sensor within the housing, the at least one optical sensor configured to selectively capture image and video data;
at least one microphone within the housing, the at least one microphone configured to selectively capture audio data;
a combined inertial sensor within the housing, the combined inertial sensor producing signals corresponding to both translation and rotation movement of the portion of the user's hand;
a haptic feedback unit within the housing, the haptic feedback unit configured to provide tactile feedback to the user;
a processor within the housing, wherein the processor is communicably coupled to and configured to receive signals from the at least one optical sensor, the at least one microphone, and the combined inertial sensor, and wherein the processor is communicably coupled to and configured to provide signals to the haptic feedback unit to generate tactile feedback events; and
a communications interface within the housing, the communications interface coupled to the processor and configured to enable the user control device to communicate with a host system.

2. The user control device of claim 1, wherein the support is a ring configured to receive a finger of the user's hand.

3. The method of claim 1, wherein the combined inertial sensor further comprises:
at least one accelerometer configured to sense acceleration of the housing in response to movement of the user's hand;
at least one gyroscope configured to sense orientation of the housing relative to gravity; and
a magnetometer configured to sense orientation of the housing relative to a geomagnetic field,
wherein the processor is configured to receive signals from the at least one accelerometer, the at least one gyroscope and the magnetometer and to generate position and orientation coordinates for the housing.
